(19) United States
(12) Patent Application Publication
(10) Pub. No.: US 2026/0008723 A1
(43) Pub. Date: Jan. 8, 2026

(54) METHOD FOR PREPARING VACUUM GLASSES

(71) Applicant: YUWEI QU, LIAOYANG (CN)

(72) Inventor: YUWEI QU, LIAOYANG (CN)

(21) Appl. No.: 18/761,427

(22) Filed: Jul. 2, 2024

(51) Int. Cl. C03C 27/10; B24B 9/08

(52) U.S. Cl. CPC C03C 27/10; B24B 9/08

(57) ABSTRACT

A method for preparing the vacuum glass including the steps of stacking two pieces of glasses. There are two nano level funnel-shaped ventilation holes inside the glass adhesive, and a nano level iron ball is placed next to each ventilation hole. The method further includes sending it into the vacuum chamber, vacuuming it, and when the chamber pressure approaches zero, activating the electrostatic field to suck out the remaining air molecules from the ventilation hole, activating the electromagnetic field, attracting the iron ball to the ventilation hole for sealing, then activating the porous hydraulic glue gun, applying glue to fix the iron ball and strengthening the sealing ventilation hole, and then exiting the vacuum chamber to obtain vacuum glass.

### FIELD OF THE INVENTION

The disclosure relates to the field of vacuum glass technologies, and more specifically, to a method for preparing vacuum glasses.

### BACKGROUND

The core point of preparing a vacuum glass is to remove the last air molecule inside the hollow glass. There is a fundamental difference between the so-called existing vacuum glass and the true vacuum glass, and its essence is still the insulating glass, which only belongs to the glass that strives to approach vacuum, namely sub-vacuum glass. The production process only involves absorbing air molecules inside the hollow body through a vacuum environment outside the hollow body. Its physical property relies on the repulsive force between air molecules inside the hollow body to repel them into its external vacuum environment, resulting in a decrease in the number of air molecules inside the hollow body, while reducing the air pressure inside the hollow body and also reducing the repulsive force between air molecules inside. When the air pressure approaches zero, the number of air molecules in it will also approach zero. But when the air pressure is zero, the number of air molecules in it must not be zero. Because the air pressure is equal to zero, it only means that the repulsive force between air molecules is equal to zero. When there is only one air molecule left in the hollow body, the repulsive force between molecules has been completely lost. The air pressure, for sure, is equal to zero, however, there is still air molecule remaining. It is difficult to extract the last air molecule from the hollow body solely by relying on the external vacuum.

At the same time, the sealing process in the existing vacuum glass production process is a very important link. It adopts a two-step method, which firstly heats the sealing edge, takes out the glass for cooling after the sealing is completed, and then performs air extraction and sealing. During this process, heating is also needed to activate and expand the air in the glass cavity, increases the air pressure, and achieves better air extraction effect. This results in a longer sealing process, higher energy consumption for heating, lower production efficiency, and greatly limits the increase of production capacity. Its production process directly leads to low vacuum degree, weak practicality, and high cost of the product. Practice has proven that sub-vacuum glass has not been widely available in the market since its inception.

Therefore, there is a need for a low-cost, non heating, and high production efficiency method for the preparation of true vacuum glass.

### SUMMARY

In order to overcome the shortcomings and deficiencies in the existing technology, the disclosure provides a preparation method for vacuum glass.

In order to achieve the above objectives, following technical solutions are adopted in the disclosure.

A method for preparing vacuum glass is disclosed. The method includes the steps as follows.

(1) Two pieces of glasses with the same size, thickness, and material are overlaid. One piece of the glasses has a set of glass hemispheres on it's inner side, and the two pieces of glass are overlaid through the corresponding tangent of the glass hemispheres.

(2) The two pieces of glass are sealed and fixed with glass adhesive to form a hollow glass chamber. The glass adhesive inside the sealed hollow glass chamber is provided with two nano level ventilation holes, and a nano level iron ball is placed next to each of the ventilation hole.

(3) The hollow glass chamber is then send into the vacuum chamber and the chamber is vacuumed by a vacuum pump. When the chamber pressure approaches zero, the electrostatic field is activated, and the remaining air molecules is sucked out through the ventilation hole with the combined force of electrostatic attraction and gravity.

(4) The electromagnetic field is activated, the iron ball is attracted to the vent for sealing, then the porous hydraulic glue gun is activated to apply glue, fix the iron ball and strengthen the sealing vent, and then exit the vacuum chamber to obtain vacuum glass.

Preferably, the radius of the glass hemisphere is R;

The ventilation hole is a fine hole end on the inner side of the cavity, with a radius of r1. The ventilation hole is located on the outer side of the cavity as a coarse hole end with a radius of r2.

3.5 nm<r1<R/2<r2<R′/2.

The beneficial effect of the above technical solution is to reasonably determine the maximum length of the ventilation hole in the sealing adhesive, which is beneficial for the process flow and product sealing quality.

Preferably, the radius of the iron ball is r3, with r1<r3<R/2.

The beneficial effect of the above technical solution is that the ventilation hole needle has a radius of r1 for the vacuum cavity and r2 for the outer hole, which is greater than r1. This can significantly enhance the sealing effect of the adhesive, while significantly reducing the resistance of the hollow cavity exhaust during the vacuum process, especially the resistance from nano-scale iron balls. The ventilation hole with a radius of 3.5 nm is still much larger than the diameter of one air molecule, which can fully ensure the unobstructed flow of gas molecules during the vacuum process.

The preferred R is 0.1 mm-0.3 mm.

The beneficial effect of the above technical solution is that the larger the R value of the glass hemisphere radius, the greater the vacuum cycle, the lower the production efficiency, and the higher the sealing cost. The smaller the R value, the more covert it is and belongs to the invisible range. It is advisable to choose an R value of 0.1 mm to 0.3 mm.

Preferably, the sealing in the step (2) adopts a porous sliding hydraulic glue gun controlled by a time switch of the pre-designed data program. The edges of the two pieces of glass are polished into a beveled shape, forming a triangular injection space.

The beneficial effect of the above technical solution is to polish the edges of the two glass pieces and seal them, which can increase the sealing area and achieve the best solid sealing effect.

Preferably, the porous hydraulic glue gun described in step (4) is set inside the vacuum chamber and can simultaneously seal the ventilation holes of a set of vacuum glass monomers. The distance between adjacent glue gun nozzles is equal to the distance between the vacuum glass monomers sent into the vacuum chamber, and each glue gun nozzle corresponds to its respective ventilation holes. It can ensure that a set of vacuum glass is simultaneously vacuum sealed and synchronously sealed.

Preferably, in the disclosure, if a diagonal of the rectangular vacuum glass is perpendicular to the horizontal line, the bottom side of the nano-scale ventilation hole is parallel to the horizontal line. The end of the ventilation hole on the inner side of the cavity is aligned with the bottom of the diagonal of the hollow glass chamber perpendicular to the horizontal line.

The angle between the opposite side of the ventilation hole (a and B respectively), Set according to the angle equal to or approaching the angle between the right angle edge of the vacuum glass and the horizontal line, there are two holes that meet this condition, which are respectively set in the sealing glue of their respective rectangular edges. The relative angles between the two ventilation holes are complementary to each other. When the vacuum glass is square, the relative side angles of the two ventilation holes are equal to or close to 45°. The angle between the direction of the two ventilation holes and the diagonal is equal to (90°-α/2) and (90°-↑/2). The direction of the ventilation hole form an angle of α/2 (β/2) with respect of the horizontal line. The relative side angle of the ventilation hole is α(β) according to the angle of the diagonal of the right angle triangle formed by the right angle edge and its diagonal of the vacuum glass.

The reasons for adopting the ventilation holes are as follows.

(1) The gravitational field of gravity can orient and attract the last air molecule inside the vacuum glass to the bottom of the vacuum glass, which is the bottom of the diagonal perpendicular to the horizontal line of the vacuum glass.

(2) The bottom side of the vent is parallel to the horizontal line, which allows the iron ball inside the vent as an air check valve to break free from the constraints of the gravity field, preventing it from flowing outward from the vent and closing it inward.

(3) The last air molecule in vacuum glass can only reach the middle of the two ventilation holes in the direction of its gravity. To ensure that it does indeed detach from the vacuum glass, the last air molecule is adsorbed onto the outside of the vacuum glass through the ventilation hole using electrostatic attraction.

From the above technical solution, it can be seen that compared with the existing technology, the disclosure provides a preparation method for vacuum glass, which has the following beneficial effects:

(1) The disclosure achieves the maximum discharge of air from the hollow glass chamber by applying nano level ventilation holes and nano level iron balls, and the prepared vacuum glass has excellent heat resistance, insulation, sound insulation, and noise reduction effects. Among them, nanoscale iron balls effectively block the volatilization of gas molecules into the limited vacuum chamber during the solidification process of glass adhesive through nanoscale ventilation holes, ensuring the ultimate goal of truly achieving a vacuum glass chamber with true vacuum.

(2) Compared with existing technologies, the disclosure does not require heating edge banding, does not use edge banding materials, has a simple production process, is easy to operate, and achieves a leap from sub vacuum technology to true vacuum technology. The reformed product will be more energy-efficient and environmentally friendly, with high production efficiency, greatly reducing production costs.

### BRIEF DESCRIPTION OF THE DRAWINGS

In order to provide a clearer explanation of the embodiments of the disclosure or the technical solutions in the prior art, the following will briefly introduce the accompanying drawings required in the embodiments or descriptions of the prior art. It is obvious that the drawings described below are only embodiments of the disclosure. For those skilled in the art, other drawings can be obtained based on the provided drawings without creative efforts.

FIG. 1 is a cross-sectional schematic diagram of the vacuum glass of the disclosure. In the drawing, ventilation hole 1, glass hemisphere 2, glass with a glass hemisphere 3, glass without a glass hemisphere 4, r1 is the radius of the fine hole end of the ventilation hole, r2 is the radius of the coarse hole end of the ventilation hole, M is the horizontal and vertical distance between adjacent glass hemispheres, R is the radius of the glass hemisphere, d is the thickness of two pieces of glass, p is the tangent point of the two pieces of glass, and R′is the thickness of the vacuum glass.

FIG. 2 is a schematic diagram of a porous hydraulic glue gun. In the drawing, glass glue hydraulic pump 5, timing and quantitative switch 6, glue gun nozzle 7, Y1 is the total distance of the glue gun, and U1 is the distance between adjacent glue gun nozzles.

FIG. 3 is a schematic diagram of a porous sliding hydraulic glue gun. In the drawing, glass glue hydraulic pump 8, timing and quantitative switch 9, glue gun nozzle 10, Y2 is the total distance of the glue gun, and U2 is the distance between adjacent glue gun nozzles.

FIG. 4 is a schematic diagram of the vacuum glass of the disclosure.

### DETAILED DESCRIPTION OF THE EMBODIMENTS

The following will provide a clear and complete description of the technical solutions in the embodiments of the disclosure. It is apparent that the described embodiments are only a part of the embodiments of the disclosure, not all of them. Based on the embodiments in the disclosure, all other embodiments obtained by ordinary technicians in the art without creative labor fall within the scope of protection of the disclosure.

### Embodiment 1

A method for preparing a vacuum glass including the following steps is disclosed.

(1) Two pieces of glasses with the same size, thickness, and material are overlaid. One piece of glass has a set of glass hemispheres on the inside, and the two pieces of glass are overlaid through the corresponding tangent of the glass hemispheres.

(2) The two pieces of glasses are sealed and fixed with glass adhesive to form a hollow glass chamber. The glass adhesive inside the sealed hollow glass chamber is provided with two nano level ventilation holes, and a nano level iron ball is placed next to each of the ventilation holes.

(3) The hollow glass chamber is send into the vacuum chamber, and vacuumed by a vacuum pump. When the chamber pressure approaches zero, the electrostatic field is activated, and rely on the remaining air molecules are suck out from the ventilation hole with combined force of electrostatic attraction and gravity.

(4) The electromagnetic field is activated, the iron ball is attracted to the ventilation hole for sealing, then the porous hydraulic glue gun is activated to apply glue, fix the iron ball and strengthen the sealing vent, and then exit the vacuum chamber to obtain vacuum glass.

The radius of the glass hemisphere is R.

The ventilation hole is a fine hole end on the inner side of the cavity, with a radius of r1. The ventilation hole is located on the outer side of the cavity as a coarse hole end with a radius of r2.

3.5 nm<r1<R/2<r2<R′/2.

The radius of the iron ball is r3, and r1<r3<R/2.

The R ranges from 0.1 mm-0.3 mm.

The sealing in step (2) adopts a porous sliding hydraulic glue gun controlled by a time switch of the pre-designed data program. The edges of the two pieces of glass are polished into a beveled shape, forming a triangular injection space.

The porous hydraulic glue gun described in step (4) is set inside the vacuum chamber and can simultaneously seal a set of ventilation holes of vacuum glass monomers. The distance between adjacent glue gun nozzles is equal to the distance between the vacuum glass monomers sent into the vacuum chamber, and each glue gun nozzle corresponds to its own ventilation hole. It can ensure that a set of vacuum glass is simultaneously vacuum sealed and synchronously sealed.

In the disclosure, if one diagonal of the rectangular vacuum glass is perpendicular to the horizontal line, the bottom side of the nanoscale ventilation hole is parallel to the horizontal line; The end of the ventilation hole pointing towards the inner side of the cavity is aligned with the bottom of the diagonal BO1 of the hollow glass chamber perpendicular to the horizontal X-axis.

The angle between the opposite side of the ventilation hole is set to be equal to or close to the angle between the vacuum glass edge and the horizontal line. There are two holes that meet this condition (α and B respectively) which are separately set in the sealing glue of their respective rectangular edges. The relative angles between the two ventilation holes are complementary to each other. If the vacuum glass is square shaped, the angle between the opposite sides of the two ventilation holes α and β≤45°. The angle between the direction of the ventilation hole O1O2 and O1O2′ and the diagonal (i.e. ∠BO1O2 and/∠AO1O2′) is ∠BO1O2≥(90°-α/2) and ∠AO1O2′≥(90°-β/2). The angle formed between the direction of the K (K′) vent with respect to the horizontal line is α/2 (β/2), where α(β) is processed within the diagonal degree of the right angle triangle formed by the right angle side and its diagonal of the vacuum glass.

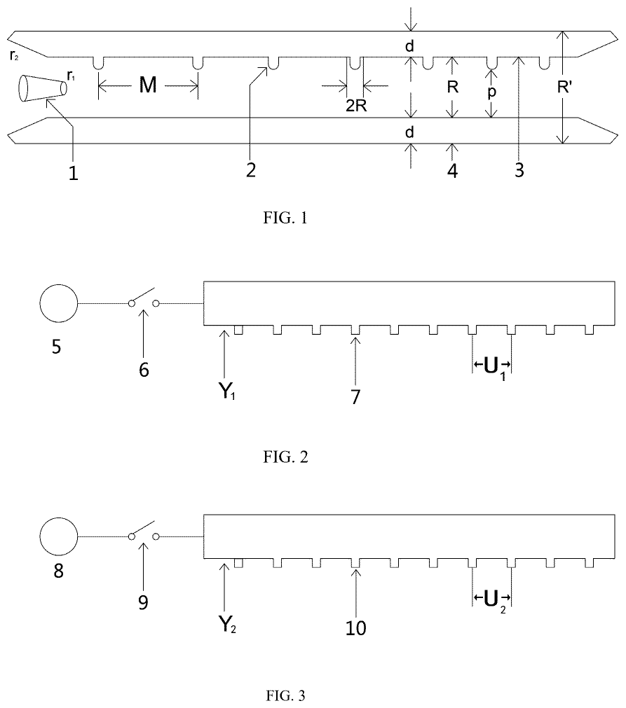

In FIG. 1, R is the radius of the glass hemisphere in the glass, 3.5 nm<r1<r2<R/2<R′/2, r1 and r2 are the radii of the fine hole end and the coarse hole end of the ventilation hole, respectively. The distance between the two pieces of glass is R, and point p is the tangent point of the two pieces of glass. The thickness of the vacuum glass obtained is R′=R+2d.

The porous hydraulic glue gun in FIG. 2 is fixed in the vacuum chamber, and each glue gun nozzle is connected to the ventilation holes of their respective monomers. The adjacent spacing of multiple glue gun nozzles is fixed according to the selected product individual spacing U1.

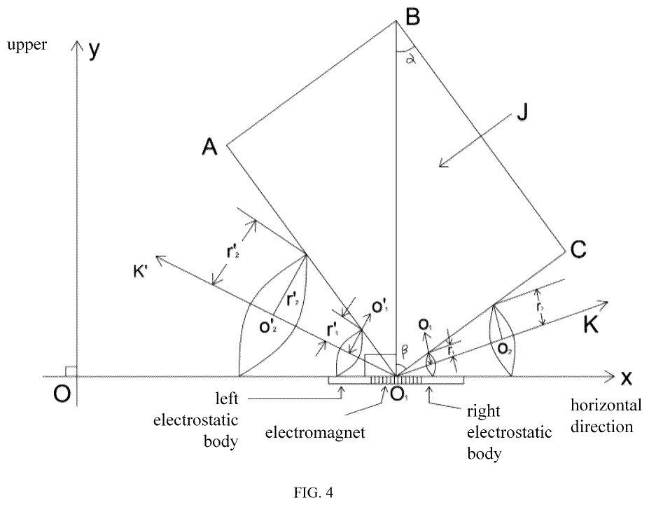

The porous sliding hydraulic glue gun in FIG. 3 is temporarily fixed on the adhesive part, and each glue gun nozzle is positioned at the sealing interface. During operation, multiple glue gun nozzles inject glue with U2 as the stroke, forming a closed glue line.

In FIG. 4, α and β are angles between the opposite sides of two nanoscale air vents. The angle α approaches or equals to ∠O1BC, β approaches or equals to ∠BO1C, then α+β≤90°. J is the rectangular vacuum chamber inside the rectangular vacuum glass. The position and direction of the two nanoscale ventilation holes in vacuum glass is determined according to ∠BO1O2≥45°+β/2 and ∠BO1O2′≥45°+α/2.

In the FIG. 1, BO1 is the diagonal of the rectangular nano glass J-cavity, where point O1 is the vertical foot of BO1 perpendicular to the horizontal X-axis, which is the lowest point of J. r1 is the radius of the nano level micro ventilation hole pointing inside J, and r2 is the radius of the micro ventilation hole pointing outside J. The angle for the opposite side of the K hole is α, i.e. ∠CO1X≥α. This selection range ensures that the fine end of the ventilation hole is inserted into the vacuum chamber and its bottom side is parallel to the horizontal direction.

Because the common cosine of ∠CO1X and ∠CBO1 is ∠BO1C, the ∠CO1X equals ∠CBO1. Because of tgα≤O1C/BC, the α is a known number while the β is also a known number.

The O1O2 is in the direction of the K, ∠CO1O2≥∠XO1O2=α/2. ∠BO1O2=∠BO1C+∠CO1O2, tg ∠BO1C=BC/O1C, ∠BO1C≥β, β=90°−α, α=90°−β, the ∠BO1O2≥β+α/2=90°−α/2, that is, the K-pore direction O1O2 forms a 90°−α/2) degree. Similarly, the angle between BO1 and K′ direction O1O2 is 90°−β/2=45°+α/2. Then ∠BO1O2′≥90°−β/2=90°−(90°−α)/2=45°+α/2. Therefore, the directions of the two ventilation holes set in the vacuum chamber both conform to half of the angle between the same diagonal BO1 of the vacuum chamber and the right angle of the other ventilation hole, and the sum of 45°, that is, ∠BO1O2′≥45°+α/2. ∠BO1O2≥45°+β/2. The theoretical data functions as the principle for determining the direction of ventilation holes.

To achieve ultimate energy conservation, the disclosure can choose one side of the glass for coating treatment, increasing the dual functions of heating and cooling the collection and filtering energy. For the installation of this product, two axes are set at the midpoint connection of the vertical edges on both sides to enable controllable rotation of the glass. To open and close the glass window, a window latch and handle that can determine the opening and closing status of the glass window should be installed at the bottom. Replace the hinges, frames, window frames, and handles of the original doors and windows separately.

The disclosure solves the technical problem that similar products cannot be popularized and promoted due to high costs, and the industry project has no risk investment, extremely simple production process, extremely easy operation, absolute vacuum effect, extreme environmental protection and energy conservation, and one-time investment that is worth more than money, which will benefit permanently. Due to its significant functions of energy conservation, noise reduction, low-carbon and environmental protection, it is a green industrial technology product that is in contrast to nuclear weapons capable of destroying the Earth countless times. Its welfare will benefit humanity, and even all living beings on Earth. Truly and effectively save electricity generated from non renewable resources on Earth (including coal, gas, fuel, and nuclear mines), while sharply reducing the harm of their power generation by-products (including greenhouse gases, toxic gases, nuclear pollutants, and other harmful substances). Truly and effectively alleviate the irreversible and destructive harm to the ecological environment, such as glacier melting, rising sea levels, and the ongoing proliferation of nuclear pollution.

According to authoritative statistics, the total annual energy consumption of the world (including fossil fuels such as coal, gas, and fuel, wind power, photovoltaic power, hydro power, tidal power, geothermal energy, and nuclear power) should be conservatively estimated to be at least 60 billion tons of coal equivalent to 2.93×107 joules per kilogram, and emit hundreds of millions of tons of smoke, greenhouse gases, and toxic gases into the atmosphere. In 2023 alone, thousands of tons of nuclear pollutants have been publicly released into the ocean, which is still ongoing. If the patented product in this case is released and popularized, and all types of buildings (such as residential houses, government agencies, schools, factories, shopping malls, sports stadiums, cinemas, hospitals, stations, docks, airports, etc.) that have been improved, as well as all types of transportation (such as cars, ships, airplanes, etc.) that have been improved, and greenhouse greenhouses that can be infinitely expanded (even used for agricultural production in the north and south poles in winter), fully utilize renewable energy solar energy, open up unused land for humanity, and effectively eliminate the three major crises of energy, food, and vegetable baskets. From the perspective of energy conservation alone, it is estimated that by saving at least 20% of the current world's annual energy consumption of 60 billion tons of coal (excluding the energy consumption that can be infinitely expanded in the future, especially the energy that greenhouse greenhouses with greater potential for expanding agricultural production should save), if the coal price is calculated at 2000 yuan/ton and the world population is calculated at 5 billion yuan, then human beings worldwide can save at least 60 billion tons×2000 yuan/ton×20%=2.4×1013 yuan per year, which is 24 trillion yuan. On average, each person can naturally benefit 24 trillion yuan/5 billion yuan=4800 yuan per year. It can be seen that the patent industry project in this case has inherent unlimited development potential, broad development space, and infinite bright development prospects. Therefore, in order to protect the ecological environment and benefit humanity in the biological world, it is imperative for the patented technology in this case to transform productivity as soon as possible.

As long as the existing technology does not achieve absolute vacuum glass and still remains in the insulating glass stage, there is a qualitative difference between it and absolute vacuum glass. Based solely on the existing technology, it can be argued that there must be significant differences in its insulation and noise reduction effects.

The relevant physical parameters in the technical field involved in the invention of this nano glass cannot be underestimated just because there are no samples available. The significant effect of heat resistance, insulation, noise reduction, and sound insulation cannot be underestimated. Taking a set of glass heat transfer coefficients jointly tested by the Swedish glass testing department and the Building Physics Department of the Chinese Academy of Sciences as an example, the heat transfer coefficients of single-layer flat glass, ordinary insulating glass, argon filled insulating glass, vacuum (sub vacuum with an internal pressure of about 0.1 Pa) glass, single-sided low radiation film vacuum (sub vacuum with an internal pressure of about 0.1 Pa) glass, double-sided low radiation film vacuum (sub vacuum with an internal pressure of about 0.1 Pa) glass and other samples are compared. Their heat transfer coefficients are in units of w/m2° C., which are 6, 3.5, 2.6, 1.5, and 1.3, respectively. The attenuation noise of insulating glass and vacuum (with an internal pressure of about 0.1 Pa and sub vacuum) glass is 28 decibels and 30 decibels, respectively. The heat transfer coefficient of the above products will inevitably be disproportionate compared to the heat transfer coefficient of the insulation bottle (Dewar bottle) invented by British physicist and chemist James Dewar in 1893. For example, when the hot water in a thermos bottle is left to drink for a day, it still feels hot. The cooling channel mainly includes the bottle mouth, and its insulation effect is so amazing because the heat transfer coefficient of the thermos bottle has approached 0, reaching a negligible level. The heat transfer coefficient of the nano glass in this invention can only and dares to be compared to that of a thermos bottle. Because the vacuum degree of both cannot be measured by air pressure, and must be measured by the presence or absence of air molecules, their heat resistance and insulation have achieved the ideal goal, and their noise reduction and sound insulation effects can be imagined based on the vacuum properties.

The various embodiments in this manual are described in a progressive manner, and each embodiment focuses on the differences from other embodiments. The same and similar parts between each embodiment can be referred to each other. For the scheme disclosed in the embodiments, the description is relatively simple as it corresponds to the method disclosed in the embodiments. Please refer to the method section for relevant information.

The above explanation of the disclosed embodiments enables professionals in the art to implement or use the disclosure. The various modifications to these embodiments will be apparent to professionals in the art, and the general principles defined in this article can be implemented in other embodiments without departing from the spirit or scope of the disclosure. Therefore, the disclosure will not be limited to the embodiments shown herein, but will conform to the widest range consistent with the principles and novel features disclosed herein.

What is claimed is:

1. A method for preparing a vacuum glass, comprising:
overlaying two pieces of glass of a same size, thickness, and material; wherein one piece of the glass is provided with a set of glass hemispheres on an inside, and the two pieces of glass are tangent to each other through the glass hemispheres;
sealing the two pieces of glass are and fixing with glass adhesive around them to form a hollow glass chamber; wherein the glass adhesive inside the hollow glass chamber is provided with two nanoscale funnel-shaped ventilation holes, and a nanoscale iron ball is placed next to each of the ventilation holes;
sending the hollow glass chamber into the vacuum chamber, vacuuming the vacuum chamber by a vacuum pump, and activating an electrostatic field when a chamber pressure approaches zero, sucking out remaining air molecules in the chamber from the ventilation holes with a combined force of electrostatic attraction and gravity;
activating an electromagnetic field, attracting the iron ball to each of the ventilation holes for sealing, activating a porous hydraulic glue gun, applying glue to fix the iron ball and strengthening a sealing of each of the ventilation hole, and exiting the vacuum chamber to obtain the vacuum glass.

2. The method for preparing the vacuum glass of claim 1, wherein a radius of each of the glass hemispheres is R; a thickness of the hollow glass chamber is R′; an opening radius of each of the ventilation hole on the inner side of the chamber is r1, and an opening radius on an outer side of the chamber is r2; wherein 3.5 nm<r1<R/2<r2<R′/2.

3. The method for preparing the vacuum glass of claim 2, wherein a radius of the iron ball is r3, and r1<r3<R/2.

4. The method for preparing the vacuum glass of claim 1, wherein the sealing is achieved by a porous sliding hydraulic glue gun controlled by a time switch of a pre-designed data program; before the sealing, polishing edges of the two pieces of glass into a beveled shape to form a triangular injection space.

5. The method for preparing the vacuum glass of claim 1, wherein the porous hydraulic glue gun simultaneously seals a set of the ventilation holes of the vacuum glass; a distance between adjacent glue gun nozzles is equal to the distance between two neighbouring vacuum glasses and each of the glue gun nozzles correspond to each one of the ventilation holes, ensuring a simultaneous vacuuming and sealing of the set of vacuum glasses.
